(19) United States
(12) Patent Application Publication
(10) Pub. No.: US 2012/0034502 A1
(43) Pub. Date: Feb. 9, 2012

(54) RECHARGEABLE BATTERY WITH CURRENT LIMITER

(75) Inventors: Kai Wei Nieh, Monrovia, CA (US); Tung-Hsiu Shih, Cerritos, CA (US)

(73) Assignee: FRONT EDGE TECHNOLOGY, Baldwin Park, CA (US)

(21) Appl. No.: 13/198,705

(22) Filed: Aug. 4, 2011

Related U.S. Application Data
(60) Provisional application No. 61/400,962, filed on Aug. 4, 2010.

(51) Int. Cl. H01M 10/50; H01M 10/04

(52) U.S. Cl. 429/62; 29/623.1

(57) ABSTRACT

A rechargeable battery comprises a battery cell comprising a plurality of battery component films on a substrate, the battery component films including at least a pair of electrodes about an electrolyte. A current limiter is electrically coupled to the battery cell to limit the current flowing through the battery cell when (i) the current flowing through the battery cell exceeds a predefined current, (ii) the temperature of the battery cell exceeds a predefined temperature, or (iii) both.

### CROSS-REFERENCE

Under 35 U.S.C. §119(e), the present application claims the benefit of the filing date of U.S. Provisional Application No. 61/400,962, filed on Aug. 4, 2010, entitled: “Rechargeable Thin Film Battery With Reduced Over-Heating”, which is incorporated by reference herein and in its entirety.

### BACKGROUND

Embodiments of the present invention relate to rechargeable batteries and related methods.

Rechargeable batteries are used as mobile power supplies for portable electronic devices such as mobile phones, tablet PC's, laptops, PDA's, remote sensors, and miniature transmitters; medical devices such as hearing aids, pacemakers, blood-pressure monitors, and implantable devices; and other applications such as smart cards, MEMS devices, PCMCIA cards, and CMOS-SRAM memory devices. The rechargeable battery should have a sufficient electrical power capacity to power the electronic device for a reasonable time. The batteries should also have high volumetric energy density to pack the most energy in the smallest battery volume to reduce the overall volume of the device. Rechargeable batteries often include a set of battery modules or battery cells connected in series or parallel.

While current lithium-ion batteries provide higher energy densities than conventional zinc-air batteries, they can overheat during charging, use, or from short circuits occurring in the battery. For example, a rechargeable battery can overheat when electrically shorted by a penetrating external conductor or by failure of the battery cells. When rechargeable batteries are used for applications in which the device is placed in close proximity to a human body, such as mobile phone, tablet pc, laptop applications and medical devices, it is undesirable for the rechargeable battery to overheat. For example, mobile phones are often used in close proximity to a human ear, and in this position, the mobile phones can become uncomfortable if they overheat. Similarly tablet PCs and laptops are also sometimes held close to the body or in a person's lap, and it is not desirable for these devices to overheat. Yet other applications include medical devices, such as hearing aids, pacemakers, and implanted devices, where it is also desirable to prevent overheating of their batteries.

While it is desirable to prevent overheating or electrically shorting in a rechargeable battery, the battery should also provide adequate power and energy storage capacity. However, these are often conflicting goals, as protective barriers that reduce or prevent electrical shorting or overheating, can substantially increase the weight and/or volume of the battery. This reduces the energy density of the battery, which in turn limits the applications of the battery and reduces its usage time. However, providing insufficient protective barriers or other safeguards to environmental degradation, reduces the safety, service life and charge capacity of the battery.

For reasons including these and other deficiencies, and despite the development of various rechargeable batteries, further improvements in battery structure, safety and energy density are continuously being sought.

### SUMMARY

A rechargeable battery comprises a battery cell comprising a plurality of battery component films on a substrate, the battery component films including at least a pair of electrodes about an electrolyte. A current limiter is electrically coupled to the battery cell to limit the current flowing through the battery cell when (i) the current flowing through the battery cell exceeds a predefined current, (ii) the temperature of the battery cell exceeds a predefined temperature, or (iii) both.

In another version, the rechargeable battery comprises a battery module comprising a plurality of battery cells, each battery cell comprising a plurality of battery component films on a substrate, the battery component films including at least a pair of electrodes about an electrolyte. A current limiter is electrically coupled to the battery module to limit the current flowing through the battery module when (i) the current flowing through the battery module exceeds a predefined current, (ii) the temperature of the battery module exceeds a predefined temperature, or (iii) both.

A method of fabricating a rechargeable battery comprises forming a battery cell comprising a plurality of battery component films on a substrate, the battery component films including at least a pair of electrodes about an electrolyte; and forming a current limiter electrically coupled to the battery cell to limit the current flowing through the battery cell when (i) the current flowing through the battery cell exceeds a predefined current, (ii) the temperature of the battery cell exceeds a predefined temperature, or (iii) both.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a schematic sectional side view of an exemplary embodiment of a rechargeable battery comprising a battery module having a single battery cell on a substrate;

FIG. 2 is a schematic top view of an embodiment of a rechargeable battery comprising a battery module having multiple battery cells;

FIG. 3 is a schematic top view of an embodiment of a rechargeable battery comprising a single battery cell having a larger anode than cathode and a current limiter;

FIG. 3A1 is a schematic top view of the detailed section 3A in FIG. 3, showing another embodiment of a current limiter comprising an interrupter line;

FIG. 3A2 is a schematic top view of the detailed section 3A in FIG. 3, showing another embodiment of a current limiter comprising a serpentine line;

FIG. 4 is a schematic diagram showing sequential fabricated structures of (left) a battery cell; (middle) a battery module comprising a plurality of battery cells with thermal conductor layers covering the battery module; and (right) a battery comprising a plurality of battery cells enclosed in a protective casing;

FIG. 5 is schematic diagram showing (middle) a sectional view of a battery module comprising a plurality of battery cells sandwiched between thermal conductor layers having current limiters thereon, and (left and right) top and bottom views of the battery module, respectively;

FIG. 6 is a photograph of a battery comprising a protective casing enclosing a stacked arrangement of four battery modules each of which have four battery cells;

FIG. 7 is a graph showing voltage versus discharge capacity for three different battery modules showing an average discharge capacity of about 12 mA-hr;

FIG. 8 is a graph of discharge capacity vs. cycle number for three different battery modules showing over 95% discharge capacity retention even after 200 charge and discharge cycles;

FIG. 9 is a graph of charge capacity vs. charge time after the 1st, 53rd, 105th, and 208th charge and discharge cycles of a battery module, showing 90% of the capacity can be recharged in one hour even after 200 cycles;

FIG. 10 is a graph of discharge capacity or charge time vs. cycle number as measured on battery cells with different total charge and discharge cycles; and

FIG. 11 is a graph of the calculated current density or discharge capacity percent versus discharge time for batteries having different lithium diffusion coefficients.

### DESCRIPTION

An exemplary embodiment of a rechargeable battery 15 comprising a battery module 20 comprising one or more battery cells 22 is illustrated in FIGS. 1 to 3. Each battery cell 22 has a thickness of 1000 microns, and can be thin film batteries which are formed by thin film fabrication processes. Generally, each battery cell 22 is fabricated on a substrate 16. The substrate 16 supporting the battery cells 22a-c can be a dielectric material having sufficient mechanical strength to support battery component films 36 and a smooth surface for deposition of thin films. Suitable substrates 16 can be made from, for example, ceramic oxides such as aluminum oxide or silicon dioxide; metals such as titanium and stainless steel; semiconductors such as silicon; or even polymers. In one version, the substrate 16 comprises a crystalline sheet formed by cleaving the planes of a cleavable crystalline structure. The crystalline cleaving structure can be, for example, mica or graphite. Mica can be split into thin crystal sheets having thicknesses of less than about 100 microns or even less than about 25 microns, as described in commonly assigned U.S. Pat. No. 6,632,563 “THIN FILM BATTERY AND METHOD OF MANUFACTURE”, filed on Sep. 9, 2000, which is incorporated by reference herein and in its entirety. Battery performance measures such as energy density and specific energy are improved by forming the battery on the thin plate-like substrates 16 of mica which increase the energy to volume/weight ratio of the battery 15.

A battery cell 22, an entire battery module 20, or an entire battery 20, can be enclosed by a protective casing 18 such that terminals 24, 26 of one or more battery cells 22, or electrical contacts 29, 30 of a battery module 20 or battery cell 15 which are electrically coupled to the terminals 24, 26 of one or more battery cells 22, extend out from the protective casing 18 to connect to an electrical power source for recharging or an external electronic device powered by the battery.

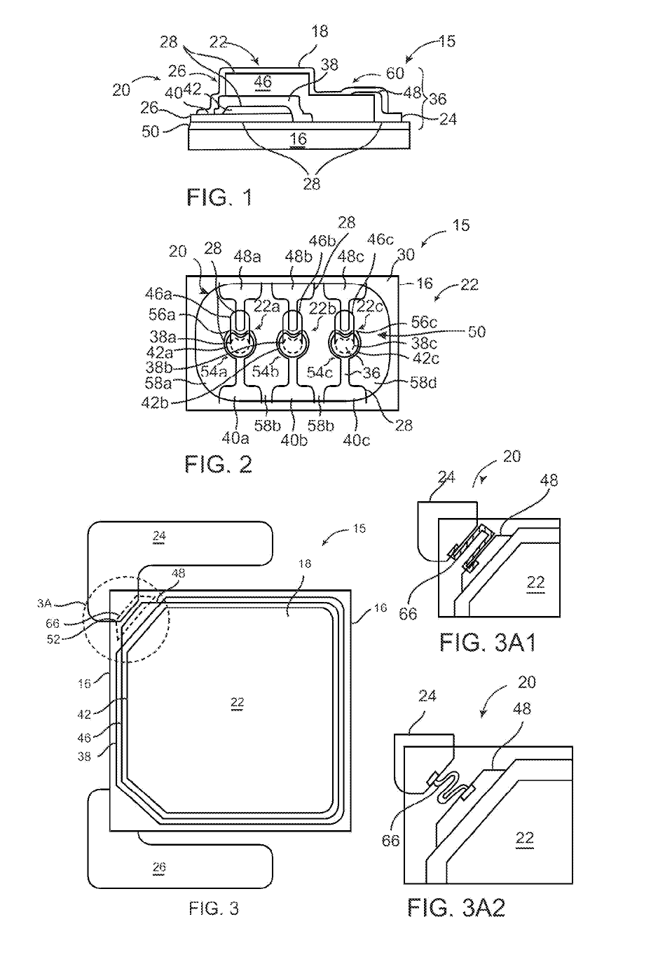

In one version, as shown in FIG. 2, the rechargeable battery 15 comprises a battery module 20 having a plurality of battery cells 22a-c formed on a substrate 16. Each battery cell 22a-c comprises a set of battery component films 36. Although the battery cells 22a-c are shown on a front surface of the substrate 16, similar battery cells 22 can also be formed on the opposing back surface of the substrate (not shown). Thus, in any of the embodiments described below, it should be understood that the battery cells 22 can be formed on either one or both of the opposing surfaces of a substrate 16, and that the scope of the present claims should not be limited to the embodiments having battery cells 22 formed only on the one side of the substrate 16.

The battery component films 36 of the battery cells 22 can have of different arrangements, shapes, sizes, or even materials, which cooperate to form a battery 15 capable of receiving, storing and discharging electrical energy. The battery component films 36 include an electrolyte 38 between at least a pair of electrodes 28. The electrodes 28 can include one or more of a cathode current collector 40, a cathode 42, an anode 46, and an anode current collector 48, which are all inter-replaceable. For example, a battery cell 22 can include (i) a cathode 42 and anode 46 or a pair of current collectors 40, 48, (ii) all of the cathode 42, anode 46, and current collectors 40, 48, or (iii) various combinations of these electrodes 28, for example, a cathode 42 and an anode 46, and anode current collector 48 but not a cathode current collector 40, and so on. The exemplary versions of the battery cell 22 illustrated herein are provided to demonstrate features of the battery cell 22 and to illustrate their processes of fabrication; however, it should be understood that the exemplary battery structures should not be used to limit the scope of the invention, and alternative battery structures as would be apparent to those of ordinary skill in the art are within the scope of the present invention. The battery component films 36 are typically less than 100 microns allowing the battery cells to be less than about 1/100^{th} of the thickness of conventional batteries. The battery component films 36 are formed by processes, such as for example, physical and chemical vapor deposition (PVD or CVD), oxidation, nitridation, and electroplating.

In one version, as shown in FIG. 2, the battery 15 comprises a battery module 20 that includes more than one battery cell 22a-c, which are all formed on an adhesion layer 50. The adhesion layer 50 can comprise a metal or metal compound, such as for example, aluminum, cobalt, titanium, other metals, or their alloys or compounds thereof; or a ceramic oxide such as, for example, lithium cobalt oxide. The adhesion layer 50 can be deposited in a thickness of from about 100 to about 1500 angstroms. Each battery cell 22a-c comprises a cathode current collector 40a-c formed on the adhesion layer 50 to collect the electrons during charge and discharge process. The cathode current collectors 40a-c are typically conductors and can be composed of a metal, such as aluminum, copper, platinum, silver or gold. The current collectors 40a-c may also comprise the same metal as the adhesion layer 50 provided in a thickness that is sufficiently high to provide the desired electrical conductivity. A suitable thickness for the cathode current collectors 40a-c is from about 0.05 microns to about 2 microns. In one version, the cathode current collectors 40 each comprise platinum in a thickness of about 0.2 microns. The cathode current collectors 40a-c can be formed as a pattern of features 54a-c, as illustrated in FIG. 3, that each comprise a spaced apart discontinuous region that covers a small region of the adhesion layer 50. The features 54a-c are over the covered regions 56a-c of the adhesion layer 50, and adjacent to the features 54a-c are exposed regions 58a-c of the adhesion layer 50. After forming the features 54a-c on the adhesion layer 50, the adhesion layer 50 with its covered regions 56a-c below the patterned features 54a-c and exposed surface regions 58a-d, is then exposed to an oxygen-containing environment and heated to oxidize the exposed regions 58a-d that surround the features but not the regions covered and protected by the features. The resultant structure, advantageously, includes not only the non-exposed covered regions 56a-c of adhesion layer 50 below the features 54a-c of the anode current collectors 48a-c, but also oxygen-exposed or oxidized regions 58a-d which form non-conducting regions that electrically separate the plurality of battery cells 22a-c formed on the same substrate 16.

Each battery cell 22a-c also includes a cathode 42a-c that comprises an electrochemically active material formed over a cathode current collector 40a-c. In one version, the cathodes 42a-c are composed of lithium metal oxide, such as for example, lithium cobalt oxide, lithium nickel oxide, lithium manganese oxide, lithium iron oxide, or even lithium oxides comprising mixtures of transition metals such as for example, lithium cobalt nickel oxide. Other types of cathodes 42a-c that may be used comprise amorphous vanadium pentoxide, crystalline V₂O₅ or TiS₂. Typically, each cathode 42a-c has a thickness of at least about 5 microns, or even at least about 10 microns. In one example, the cathodes 42a-c each comprise crystalline lithium cobalt oxide, which in one version, has the stoichiometric formula of LiCoO₂.

An electrolyte 38a-c is formed over each cathode 42a-c. The electrolytes 38a-c can be, for example, an amorphous lithium phosphorus oxynitride film, also known as a LiPON film. In one embodiment, the LiPON has the stoichiometric form LiₓPO_{y}N_{z} in an x:y:z ratio of about 2.9:3.3:0.46. In one version, the electrolytes 38a-c have a thickness of from about 0.1 microns to about 5 microns. This thickness is suitably large to provide sufficiently high ionic conductivity and suitably small to reduce ionic pathways to minimize electrical resistance and reduce stress.

An anode 46a-c is formed over each of the electrolytes 38a-c. The anode 46a-c can be the same material as the cathode 42a-c, as already described. A suitable thickness is from about 0.1 microns to about 20 microns. In one version, the anodes 46a-c are made from lithium which is also sufficiently conductive to also serve as the anode current collector 48a-c, and in this version the anode 46a-c and anode current collector 48a-c are the same structure. In another version, the anode current collector 48a-c is formed on the anode 46a-c, and comprises the same material as the cathode current collector 40a-c to provide a conducting surface from which electrons may be dissipated or collected from the anode 46a-c. For example, in one version, the anode current collector 48a-c comprises a non-reactive metal such as silver, gold, platinum, in a thickness of from about 0.05 microns to about 5 microns.

In one version, the charging properties of the battery cells 22a-c are improved by the structure of the battery cells. For example, in the version shown in FIG. 3, the relative surface areas of the anode 46 and cathode 42 are controlled by rendering the cathode 42 slightly larger in area than the anode 46 as shown. It has been discovered a battery cell 22 comprising an aerial portion of cathode 42 extending beyond the edge of the anode 46 takes a long time to fully charge the extra cathode volume or region. For example, a cathode 42 that has an area that is from about 1 to about 5% larger that the area of the anode 46 of the battery cell can result in battery taking tens of hours longer to fully charge. Further, in a typical charge condition used for charge/discharge cycle tests, the extra cathode volume extending beyond the perimeter of the anode 46 cannot be fully recharged. Still further, the energy capacity of the outwardly extending region of the cathode 42 gradually diminishes over charge/discharge cycles more than the portion of the cathode 42 that does not extend beyond the surface of the anode 46. Thus, in the version shown in FIG. 3, the structure of the battery cell 22 was modified to make the anode 46 slightly larger in surface area than the cathode 42. In one version, the anode 46 as an area that is at least about 2% larger, or even about 2% larger, than the area of the cathode 42. For example when the cathode 42 has an area of from about 0.24 cm² to about 3 cm²; the corresponding anode 46 of the same battery has an area of from about 0.28 cm² to about 3.2 cm².

The dimensions of the anode 46 and cathode 42 can also be altered for better battery charging properties. For example, fabricating the anode 46 to be thicker than the cathode 42 by about 2 microns to about 20 microns, or even by about 5 to about 8 microns, can reduce charging time. Both the surface area and thickness modifications minimize the roughening off the anode 46 after charge/discharge cycling which is responsible for most of the fade in charging capacity after multiple charge and discharge cycles.

Yet another method of reducing the charging time of the battery cell 22 is to reduce the thickness of the cathode to be less than 20 microns. In one version, the cover thickness is reduced from greater than 18 microns, for example, 18.7 to less than 18 microns, for example 17 microns. The smaller cathode thickness reduces the overall energy density of the battery cell 22 that significantly improves the cycle life.

A conducting bridge 52 can also be used to connect the anode 46 to the terminal 24. When the anode 46 is made from lithium, and the terminal 24 is made from a material which is not compatible with lithium, such as platinum, the conducting bridge 52 prevents undesirable chemical reactions between the lithium anode 46 and the terminal 24. In one version, the conducting bridge 52 is made from a conducting metal, for example, copper. The conducting bridge 52 can be deposited below the anode 46. For example when the anode 46 comprises lithium, it is desirable not to expose the lithium to the environment, and this can be avoided by depositing the conducting bridge 52 before deposition of the lithium anode 46.

As one example, a rechargeable battery 15 comprises a battery module 20 composed of a single battery cell 22 having a cutout dimension of about 14×14 mm and a surface area of about 1.96 cm². The cathode thickness is about 18.73 microns and the anode thickness is about 5 microns to give a total battery cell having a thickness of about 88 microns. The cell capacity is 3.14 mA/hr @ 4.2 V and the cell energy density is about 710 Wh/L. In another example, A rechargeable battery 15 comprising a battery module 20 composed of four battery cells 22 has a module capacity of about 12.6 mAh @ 4.2 V, and a module energy density of about 539 Wh/L.

As another example, a rechargeable battery 15 comprises a battery module 20 composed of a single battery cell 22 having a cutout dimension of about 13.8×13.8 mm, and a surface area of about 1.90 cm². The cathode thickness is about 17 microns and the anode thickness is about 8 microns to give a battery cell having a total thickness of about 89 microns. The battery cell capacity is 2.76 mA/hr @ 4.2 V, and the cell energy density is about 635 W h/L. In another example, the rechargeable battery 15 comprises a battery module 20 composed of four of such battery cells 22 provides a module capacity of about 11 m/Ah @ 4.2 V, and an energy density of about 507 Wh/L.

After the deposition of all the battery component films 36, a protective casing 18 can be formed over the battery component films 36 to provide protection against environmental elements. In one example, the protective casing 18 comprises one or more of a metal film, epoxy barrier, or a plurality of polymer, metal or ceramic layers superimposed on each other. In one version the protective casing 18 comprises layers of polymer and ceramic layers which are deposited over one another. A suitable polymer comprises polyvinylidene difluoride or polyurethane, and a suitable ceramic comprises aluminum oxide or diamond like carbon. Portions of the cathode current collector 40 and anode current collector 48 that extend out and beyond the protective casing 18 surrounding the battery cell 22 to form a pair of terminals 24, 26 which are used to connect the battery cell 22 of the battery cell 22 to one another, or to the contacts of a battery module 20, which in turn are connected to the external environment. In one version, the protective casing 18 around the battery 20 can be made only from a polymer layer and limited to a thickness of from about 5 to about 50 microns, or even from about 10 to about 20 microns. The reduced thickness of a protective casing 18 further increases the energy density of the battery 20.

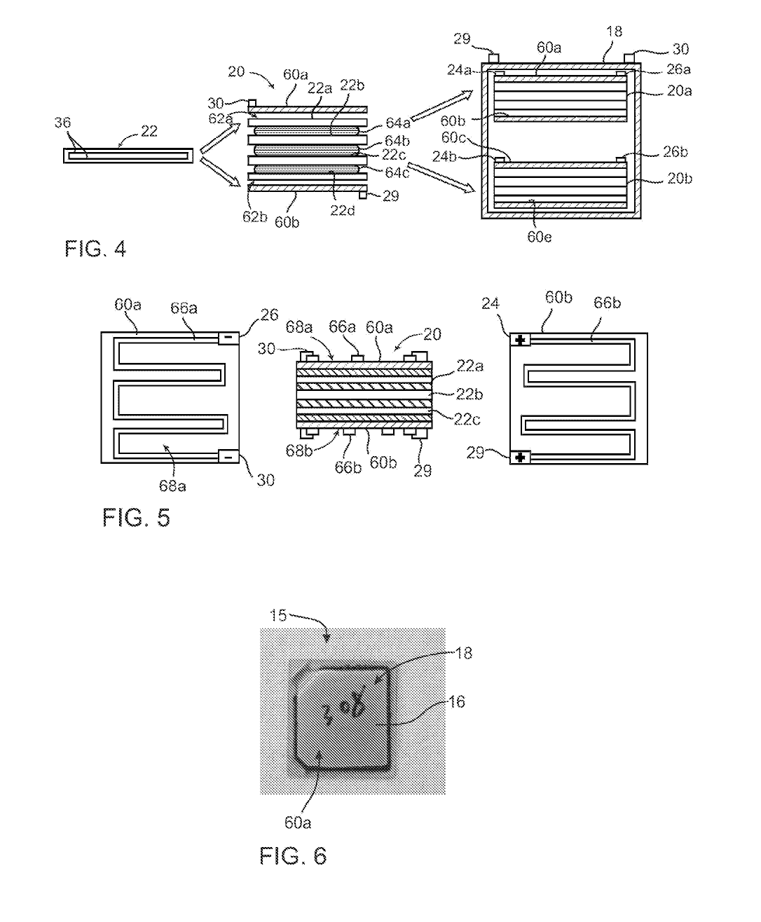

Overheating of individual battery cells 22 of a battery module 20 forming a rechargeable battery 15 can be reduced or dissipated by providing one or more thermal conductor layers 60 between vertically stacked battery cells 22. The thermal conductor layers 60 can be placed between the different protective casing 18 that protect individual battery cells 22 from the environment, or can even be formed as a portion of the protective casing 18. The sequential steps of fabricating an exemplary battery 15 comprising a battery module 20 having a plurality of battery cells 22 with thermal conductor layers 60 between the battery cells are shown in FIG. 4. As shown, a battery cell 22 comprising a plurality of battery component films 36 is initially fabricated as described above. A plurality of the battery cells 22a-d are then vertically stacked over one another and assembled into a battery module 20. The battery cells 22a-d can be joined to one another with a gap therebetween or with a sealant such as a thermoplastic or thermoset polymer between the battery cells 22a-d. A pair of thermal conductor layers 60a,b are then fabricated over the stack of battery cells 22a-d to cover the top and bottom exposed surfaces 62a,b of the stacked battery cells. The terminals 24, 26 of the battery cells connected to one another (not shown) in a parallel or series arrangement, to terminate at the electrical contacts 29, 30 of a battery module 20.

In one version, the thermal conductor layers 60a,b each comprise a layer of a metal, metal compound, or metal alloy. For example, the thermal conductor layers 60a,b can be made of aluminum, copper, tin, silver or steel. The thermal conductor layers 60a,b can be in the form of a metal foil, for example, having a thickness of less than about 50 microns, or even less than about 5 microns. In one example, a suitable foil is composed of, or even consisting entirely of, aluminum. The thermal conductor layers 60a,b can be laminated over the stacked battery cells 22a-d after the battery cells are laminated to one another or in the same lamination process as that used to join the battery cells 22a-d to one another. For example, in one process, a layer of sealant 64a-c is placed over the top surface, or along the exposed side perimeters, of each of the battery cells 22a-d as shown in FIG. 4. The thermal conductor layers 60a,b are then placed over the top surfaces 62a,b of the stack of battery cells 22a-d. The entire stack is then laminated in an autoclave to form a battery module 20.

One or more battery modules 20a,b that each have a pair of thermal conductor layers 60a,b and 60c,d, are then stacked over one another to form a battery 15. The entire assembly can be joined together with additional sealant placed between the battery modules, or simply by forming a protective casing 18 around the stack of battery modules 20a,b to hold the modules together. Also, the terminals 24, 26 of the different battery modules are connected to one another in series or in parallel and extend out of the protective casing 18 to connect to the external environment.

The thermal conductor layers 60 dissipate local heat and thereby reduce or even prevent the formation of localized hot spots that give rise to overheating in the battery 15. The localized hotspots can occur when a battery cell 22, battery module 20 or the battery 15 is electrically shorted. For example, if a sharp metallic object pierces the external protective casing 18 of the battery cell 22, battery module 20, or battery 15, it can cause an electrical short and localized overheating at the point of rupture. Accordingly, the external protective casing 18, sealant 64, and the terminals 24, 26 of the individual battery cells 22a-d or the battery modules 20a,b, can all be part of the over-all thermal management structure to prevent overheating arising from such or other electrical shorting. The thermal conductor layers 60 substantially prevent overheating or other damage to the battery 15. For example, the thermal conductor layers 60a-d can also dissipate heat of an electrical charge when sharp objects are accidentally inserted through the battery 15. For example, in experiments in which a sharp metal object was driven through the surface of the battery module 20 (or a battery 15 having a number of battery modules 20), the thermal conductor layers 60a-d not only prevented overheating of the battery and electrical shorting, but also reduced the possibility of implosion of the battery 15.

In still another version, each battery module 20 also includes one or more current limiters 66 or 66a,b as shown in FIGS. 3, 3A1, 3A2, and 5. Referring to FIG. 3, a current limiter 66 can be placed to electrically couple the anode 48 and a terminal 24 of a battery cell 22. In this version, the current limiter 66 would replace the conducting bridge 52. The current limiter 66 limits, or even interrupts, the current flowing into or out of the battery cell 22 when (i) the current passing through the battery cell 22 exceeds a predefined current, (ii) the temperature of the battery exceeds a predefined temperature, or (iii) both. By limiting or interrupting the current flowing into the battery cell 22, the current limiter 66 can prevent localized overheating of the cell that would otherwise arise from an electrical short, or abnormal charging or discharging problem. For example when an external object penetrates the protective casing 18 of the battery cell 22, the current limiter 66 would detect the sudden surge in electrical current and limit or interrupt the current flowing to or from the cell 22. The current flowing from the cell 22 can be limited by a sudden increase in resistance of the material of the current limiter 66 when the current threshold level is exceeded. Alternatively, the current flowing from the cell 22 can be interrupted when the current limiter 66 breaks the electrical connection to the battery cell 22 by flowing, melting or vaporizing. In one version, the current limiter 66 limits, or even interrupts, the current flowing into or out of the battery cell 22 when the current passing through the battery cell 22 exceeds a current of 20 mA, or even exceeds a current of 30 mA. In another version, the current limiter 66 limits, or even interrupts, the current flowing into or out of the battery cell 22 when the temperature of the battery exceeds a temperature of at least about 100° C., or even at least about 200° C., or even at least about 300° C.; such as for example a temperature of from about 100° C. to about 200° C.

The current limiters 66 can have different shapes, for example, shaped as a patch as shown in FIG. 3, an interrupter line as shown in FIG. 3A1, or a segmented line as shown in FIG. 3A2. In any of these versions, the current limiter 66 is made of a material that increases resistance, melts or vaporizes when a threshold current or a threshold temperature is exceeded. For example, the current limiter 66 can be made of a material that increases resistance by at least about 10 ohms when subjected to a current that exceeds 20 mA. In another version, the current limiter 66 increases resistance by at least about 10 ohms when heated to a temperature that is at least about 100° C., or even at least about 200° C., or even at least about 300° C. In still another version, the current limiter 66 is made from a material that flows or melts at a localized temperature that is less than about 300° C., or even less than 200° C., or even less than about 150° C. Suitable materials for fabricating the current limiter 66 include at least one of indium, tin, bismuth or their alloys.

The current limiter 66 can be formed by depositing the selected material directly on the substrate 16, on a battery component film 36, on a thermal conductor layer 60, or on the protective casing 18, using conventional thin film deposition processes such as PVD (sputtering) or CVD, and can be shaped using conventional lithography and etching processes or using a mask during a deposition process. For example, a current limiter 66 can be formed by sputtering material through a mask having a pattern corresponding to the desired patch shape or a line shape. In certain versions, the current limiter 66 is shaped as a line, which can be convoluted, such as a serpentine shape, to maximize the length of the line. In one example, the current limiter 66 can be a plurality of parallel lines that are connected at their extremities to form a connected box as for example shown in FIG. 3A1, or can be a arcuate, serpentine line as shown in FIG. 3A2. The current limiter 66 can also be shaped as a spiral or circular pattern, or other pattern as would be apparent to those of ordinary skill in the art. In any of the line shapes, the current limiter 66 can be formed as a thin line having a linewidth of less than about 50 microns, or even from about 20 microns to about 5 microns; and a length of at least about 5 mm, or even from about 10 mm to about 50 mm.

Referring to FIG. 3A1, which is a schematic top view of the detailed section 3A in FIG. 3, a current limiter 66 comprising an interrupter line is positioned between the anode 48 and the terminal 24 of a battery cell 22. In this version, the current limiter 66 comprises an interrupter line comprises two or more parallel line segments joined to one another at a middle end, and terminating at the anode 48 and terminal 24. The current limiter 66 can be deposited underneath or over the anode 48 and terminal 24. In one version, the current limiter 66 is deposited below the anode 48 when the anode 48 is composed of lithium to reduce exposure of the lithium to the environment during subsequent process steps which would otherwise be required for the deposition of the current limiter 66. Another embodiment of a current limiter 66 comprising a serpentine line as shown in FIG. 3A2, comprises a convoluted, serpentine line that electrically connects the anode 48 to the terminal 24.

In FIG. 5, the middle schematic diagram shows a sectional view of the battery module 20 comprising a plurality of battery cells 22a-c sandwiched between the thermal conductor layers 60a,b. In this version, one or more current limiters 66a,b can be placed on either the top surface 68a, or the bottom surface 68b, of the thermal conductor layers 60a,b, respectively, or on both surfaces. Typically, a single current limiter 66a or 66b is formed on either the top or bottom surface 68a,b of the thermal conductor layers 60a,b, respectively. Either of the current limiters 66a,b can limit, or even interrupt, the current flowing into or out of the battery module 20 when (i) the current passing through the battery module 20 exceeds a predefined current magnitude, (ii) the temperature of the battery exceeds a predefined temperature, or (iii) both. The current limiters 66a,b can be formed directly on the thermal conductor layers 60a,b using thin film deposition and/or etching processes. For example, the current limiters 66a,b can be formed by sputtering material through a mask having a pattern corresponding to the patterned line of the current limiters 66a,b. In any of these versions, the current limiters 66a,b can be shaped to maximize their length, for example, with a plurality of parallel lines that are connected at their extremities to form a connected box line as shown in FIG. 5. The current limiters 66a,b can also be shaped as a spiral or circular pattern, or other pattern as would be apparent to those of ordinary skill in the art.

The current limiters 66a,b extend from a terminal 24, 26 of the first or last battery cell 22a,c, respectively, to the electrical contacts 29, 30, respectively, of the battery module 20 or battery 15. In this arrangement, the current limiters 66a,b are in the electrical pathway of the current entering or exiting the battery module 20. As such, the current limiters 66a,b can break off the electrical connection between the battery module 20 or battery 15 and the external environment when the current to the battery module 20 or battery 15 exceeds a predetermined value or when the localized temperature exceeds a predetermined level. The predetermined breaking current or temperature value depends on the structure and material of the current limiters 66a,b, which essentially, serve as fuses that break and disconnect the electrical circuit.

Limiting the thickness of the cross-sectional area of the current limiters 66a,b decreases its current carrying capacity and increases its resistance. Similarly, increasing the length of the current limiters 66a,b also increases their resistance. So a longer length, and smaller cross-section area, would reduce the current or temperature at which the current limiters 66a,b would limit or interrupt the current level allowed therethrough. Computer modeling and experimental measurement can be conducted to determine the temperature change that would occur when a battery module is electrically shorted as described below to arrive at the optimal maximum current or temperature level for a particular battery configuration.

In one version, the current limiters 66a,b are formed on thermal conductor layers 60 comprising a metal foil sandwiched between polymer layers. In this version, the current limiter 66a,b comprises an interrupter line that is superimposed onto a thermal conductor layer 60a,b, and serves as a fuse that limits or breaks electrical connection upon reaching a particular temperature or current. The thermal conductor layers 60a,b are used as the top and bottom covers of a battery module 20 comprising a number of battery cells 22a,b that are each formed on mica substrates 16. The metal foils serve as both a portion of the protective casing 18 as well as the thermal conductor layer 60, and can be made from metal such as aluminum, copper, stainless steel. The metal foils are coated with an insulating polymer material, such as Parylene (which is a chemical vapor deposited poly(p-xylylene) polymer) to prevent shorting the battery module 20. In one version, one or more current limiters 66a,b are deposited or laminated on the paralyne coated metal foils, and each comprise an interrupter line composed of a indium-tin alloy, then having a linewidth of about 10 microns to about 50 microns, and a thickness of less than 10 microns. This indium-tin alloy melts and/or creates a high resistance when exposed to localized temperatures that exceed about 150° C. In an exemplary fabrication process, a target comprising a solid piece of indium-tin alloy is used as the source material. The deposition can be carried out by either thermo-evaporation or sputtering. The line width, length and the shape are defined by a shadow mask placed on the battery module 20 during the deposition process. In another example, a current limiter 66a,b comprising an interrupter line, is formed by laminating a foil having a predefined thickness and line shape onto a thermal conductor layer 60a,b or the protective casing 18 of a battery 15 or battery module 20 using thermoplastic or thermo-set polymers.

To minimize the volume off the battery module 20, the current limiters 66a,b can also be integrated into the thermal conductor layers 60a,b by integrating a suitable electrical circuit into the layers 60a,b. For example, a battery module 20 comprising a plurality of battery cells 22a-c can have one or more current limiters 66a,b integrated onto thermal conductor layers 60a,b covering a battery module 20. By integrated it is meant that the current limiters 66 are within the structure of the thermal conductor layer 60, or even form the same structure. For example, a current limiters 66 can be a current-limiting line that is sandwiched between two or more thermal conductor layers 60a,b.

The current limiters 66a,b can also be applied to control overheating or electrical shorting of an entire battery 15. In this version, the current limiters 66, and optional thermal conductor layers 60a,b, are applied over the protective casing 18 of the entire battery 15 and not just the battery modules 20. The protective casing 18 can also include a thermal conductor layer 60 with the current limiter 66 formed thereon (not shown). This version prevents overheating resulting from the current flowing into or out of a failed battery 15.

The current limiters 66a,b also serve to shut-off or limit the current flow into a failed battery 15 or battery module 20 to prevent dumping of stored energy from other connected batteries 15 into the failed battery or from other battery modules 20 into a failed module. In this capacity, the current limiter 66a,b operate as temperature-sensitive sensors o cut the failed battery 15 or battery module 20 out of the battery circuit which connects the failed battery 15 or module 20 to other batteries or to an external device. The current limiter 66a,b interrupt the circuit at a predefined temperature to act as a temperature-sensitive sensor which connects each battery 15 or battery module 20 to an external device to limit or interrupt the current flowing therebetween when the predefined temperature is reached. The predefined temperature can be a temperature indicative of general overheating of a particular battery 15 or battery module 20, or a temperature indicative of a failed battery state.

Advantageously, each battery cell 22 is a solid state battery, and as such, does not release extra energy from liquid electrolyte-based reactions. However, an excessively rapid release of the stored energy of the battery cells 22 within the confines of the small area of a battery module 20 or battery 15 may still cause localized heating that results in battery temperatures that can exceed at least about 100° C., or even at least about 200° C., or even at least about 300° C. Such local heating effects can initiate undesirable chemical reactions of the battery component films 36 such as the anode 46, or the protective casing 18, with the ambient air. This problem is exacerbated for small footprint, high energy density batteries. Thus, in one example, the current limiter 66a,b which serves as a temperature-sensitive sensor is made from a material which flows or melts at a localized temperature that is less than about 300° C., or even less than 200° C., or even less than about 150° C. In one version, the current limiter 66a,b can melt or flow at a temperature of from about 100° C. to about 200° C., such as for example, about 130° C. Suitable materials include at least one of indium, tin, bismuth or their alloys. These materials can be applied in the form of a thin line having a linewidth of less than about 50 microns, or even from about 20 microns to about 5 microns, and in a length of at least about 5 mm, or even from about 10 mm to about 50 mm.

The number of battery cells 22a-c in a battery module 20 can also affect the energy density and safety considerations of the resultant battery 15. For example, stacking a larger number of battery cells 22 in a battery module 20 increases the energy density but lowers the manufacturing yield, and in use, also increases the risk of overheating. Thus, in one version, each of the battery modules 20a,b, etc., comprises less than 10 battery cells 22, or even less than 4 battery cells.

The embodiment of the rechargeable battery cell 22 described herein provides better user safety by reducing the possibility of excessive heat accumulation in small confined regions within a battery cell 22a-c, battery module 20a,b or battery 15. In doing so, the possibility of generating sufficient heat build-up in a battery cell 22a-c, module 15, or battery 15, which could potentially burn a user is reduced. The current batteries 15 also provide higher energy storage capacity and better volumetric energy density than conventional lithium-ion batteries. For example, conventional lithium-ion battery cells often have maximum energy density levels of 200 to 350 W-hr/l and specific energy levels of 30 to 120 W-hr/L. However, the present battery 15 has an energy density level exceeding 300 W-hr/L, or even exceeding 500 W-hr/L. In addition, the battery 15 provides a total stored charge of 12.5 mA-hr. Also, the capacity retention at the level of the battery cells 22a-c after 1,200 charge and discharge cycles is typically from about 55% to about 85%, with most of the capacity loss occurring in the first 300 cycles, and with less than 5% capacity loss occurring from 300 to 1200 cycles.

The following examples illustrate exemplary embodiments of the present battery, fabrication methods, and test results, but should not be used to limit the scope of the present invention

### EXAMPLE I

A photograph of a battery 15 comprising four battery modules 20 (not shown) that each have four battery cells 22 (not shown) is shown in FIG. 6. The battery 20 was fabricated on a substrate 16 comprising a mica sheet, with a protective casing 18 surrounding the battery that includes a thermal conductor layer 60a on the top surface of the battery as shown. The battery 15 has overall aerial dimensions of 14 mm×14 mm and a thickness of 0.46 mm, and provided a volumetric energy density of 539 Watts-hr/L. The battery 20 was charged with a charge time of 90% in 1 hour of charging. Also, the charge capacity retention after 200 charge and discharge cycles was about 96%. These results represent excellent energy density, charging, and charge capacity retention compared to prior art batteries.

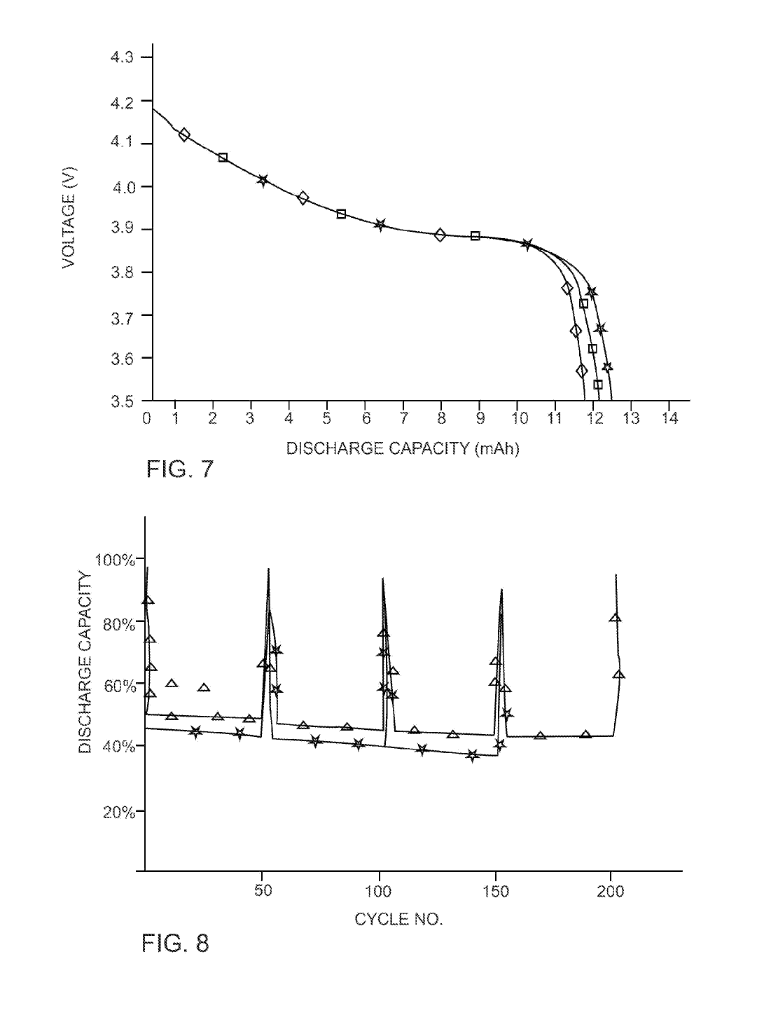

The voltage versus discharge capacity of each of three different battery modules 20 of the battery 15 is shown in FIG. 7. This graph demonstrates a battery discharge capacity of more than 12 mA-hr at a test temperature of about 30° C. The discharge capacity was measured using 16-hour discharge rate (0.75 mA discharge current). This discharge rate is a typical one-day-operation of a mobile phone or a medical device such as a hearing aid. The highest discharge capacity was 12.55mAh. The energy density of the battery modules 20 was estimated at about 539 Wh/L.

The battery modules 20 were also tested for its charge/discharge cycle life and charge rate at a test temperature of about 30° C. The cycle test conditions were:

(i) charge at 4.2V constant voltage, no current limit, until the charging current drops to 6 mA;

(ii) discharge at 12 mA constant current to 3.6V;

(iii) cycle for 200 cycles; and

(iv) measurement of the capacity at 16-hr rate after every 50 cycles.

The test results of discharge capacity vs. cycle number for different cycles of three different battery modules 20 are shown in FIG. 8. The first battery module 20 completed over 200 cycles with only 4% capacity fade at the end of 200 cycles. It was also determined that over 90% of the charge capacity can be recharged in one hour when charged at 4.3V and a test temperature of 30° C.

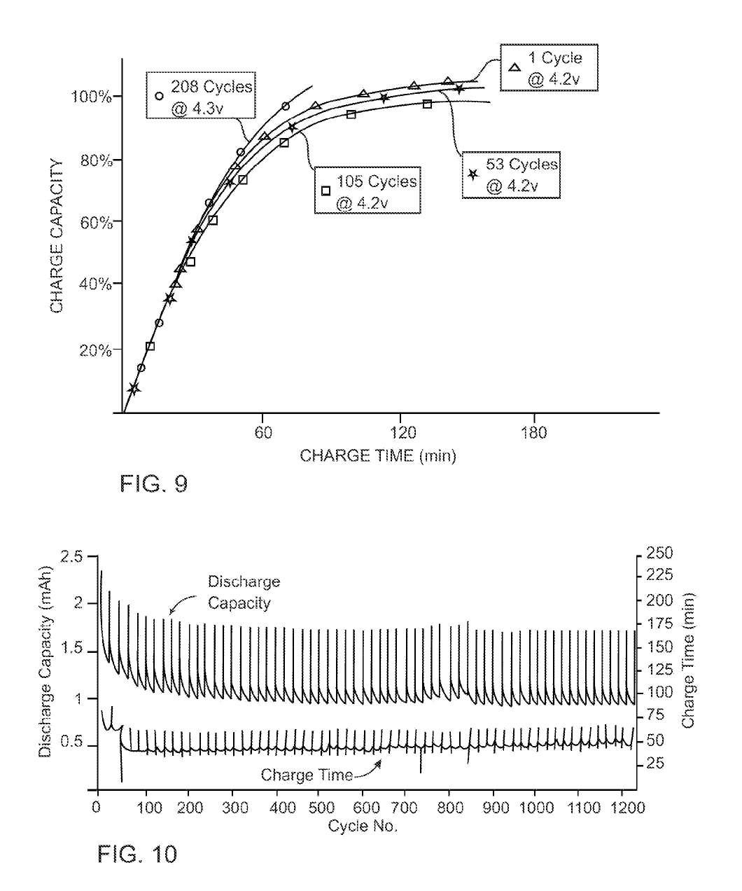

A graph of charge capacity vs. charge time of different batteries is shown in FIG. 9. The charge capacity vs. time was measured after the 1st, 53rd, 105th, and 208th discharge cycles. The charge after 1st, 53rd, and 105th discharges were carried out at 4.2V. The charge capacity retention was 96% after 200 cycles when discharged at 16-hour rate and 30° C. As seen, all the batteries were charged to 80% within one hour and 97% within two hours under this charge condition. The recharge after the 208^{th} discharge was carried out at 4.3V. At this charging voltage, the module was recharged to 90% of the full capacity in one hour and 100% in 80 minutes. This charge rate meets the desirable goal of 90% in one hour. Still further, the high voltage charging procedure did not affect the battery cycle life.

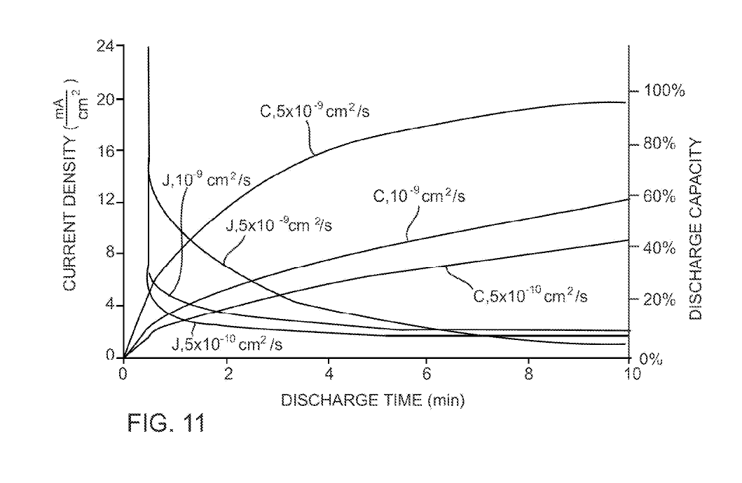

The cycle life of single battery cells 22 were also tested as shown in FIG. 10. The low rate capacity retention after 300 cycles is about 55% and about 50% after 1200 cycles. The best battery cell 22 was cycled for more than 1200 cycles. The low rate capacity retention after 300 cycles is about 550%. There was only about 5% capacity loss from 300 cycles to 1200 cycles.

### EXAMPLE II

In this example, the procedure for calculating the temperature distribution and profile of a battery 15 (or module 20 or battery cell 22) that is short circuited based on simplified models is demonstrated. The calculation results can be used to determine the type of material and the properties of the thermal conductor layer 60 and the current limiter 66 needed t prevent overheating or thermal failure during short circuit. The models can also demonstrate whether an external electrical short or an internal electrical short can cause the worst-case thermal situation. The temperature rise can be experimentally determined for both modules and batteries for the worst-case failure mode. While the models are described in the context of a battery 15, it should be understood that they can be equally applied to a battery module 20 or to a battery cell 22.

To calculate the temperature profile that occurs in a battery 15 after electrical shorting, the amount and the rate of energy release from the battery 15 when a short occurs will first be calculated. It is assumed that most of the heat is released at the location of the electrical short, for example, at the point of rupture of the protective casing 18 of the battery 15 by an external sharp metal object. Using the energy release profile and the simplified heat propagation models, the temperature rise can be calculated for different module and battery structures.

Initially, the rate of energy release during the electrical shorting is calculated. During the initial electrical shorting stage, the Li ion concentration x in a cathode comprising LiₓCoO₂ will change from 0.5 (fully charged state) to 1 (fully discharged state) in a short time. The rate of energy release is dominated by the Li-ion diffusion rate in the cathode which can be calculated by the following 1-dimensional exact solution assuming a constant Li diffusion coefficient D (in cm²/s) in cathode,

$$Creleased = 1 - {\sum }_{0}^{∞} \frac{8}{{( 2 n + 1 )}^{2} {π}^{2}} exp \{ - {D ( 2 n + 1 )}^{2} {π}^{2} t / 4 {l}^{2} \}$$

where C_{released} is the proportion of released capacity, l (in cm) is the thickness of the cathode 42 of the battery 15, and t (in s) is the time after shorting. The current l (in mA) and the current density J (mA/cm²) can be derived from the slope of the above equation as follows,

$$I = \frac{{C}_{total}}{3600} \frac{Δ {C}_{released}}{Δ t} and J = \frac{{C}_{total}}{3600 A} \frac{Δ {C}_{released}}{Δ t}$$

where Cₜₒₜₐₗ (in mAh) is the total capacity and A (in cm²) is the total active area. A plot of the released capacity and current density profiles For a cathode 42 having a thickness of 15 microns with different became ion diffusion coefficients (D) is shown in FIG. 11, which shows a graph of the calculated released capacity (C released) and current density (J) profiles of batteries that are electrically shorted. In this graph, the dashed line is the upper limit of the current density (˜21 mA/cm²) at the beginning of the shorting due to the internal resistance of the solid state electrolyte 38. For a cathode 42 having a thickness of 15 microns, about 0.7% of the total capacity will be released in the first second after shorting. At 30 seconds after shorting, the released capacity is about 13% and the current density drops to 6.5 mA/cm² for a typical Li-ion diffusion coefficient of 1E-09 cm²/s. The simulation can be further developed to include a non-constant diffusion coefficient as a function of Li concentration, and to include the voltage drop across electrolyte 38.

Thereafter, the temperature profile of the battery 15 is modeled using a three-dimensional heat dissipation simulation model & calculation program, to calculate the temperature profile near the electrical shorting spot. The calculated released capacity profile and an estimated size of the electrical short (typically 10 microns) is used in the simulation. For a given simulation time iteration delta(t), the heat (q) transfer in/out of an element volume is proportional to the negative of temperature gradient by the following Fourier's law,

q=−κ∇T

where k is the thermal conductivity. The temperature gradient can be calculated by delta(T)/delta(x), delta(T)/delta(y) and delta(T)/delta(z) in the simulation processing. A change in internal heat per unit volume, ΔO, is proportional to the change in temperature, ΔT. That is,

ΔQ=cₚρΔT

where cₚ is the specific heat and p is the density of the material. Therefore, the change in temperature can be calculated for each simulation element according to net heat transfer in or out of that element, to model the temperature-time profile of the electrical shorted battery 15.

The temperature profile of a battery cell 22, battery module 20 or battery 15, that is electrically shorted by an internal or external shorting point can also be measured. For example, three different types of shorting can be evaluated, namely, an external short, internal short due to a metallic inclusion, and internal short induced by a penetrating nail that penetrates through the protective casing of a battery cell 22, battery module 20, or battery 15. An internal short can be simulated by introducing a metallic inclusion or by nail penetration. The external short is through a low resistance wire (not shown) connecting the positive and negative contacts of the battery cell 22, battery module 20, or battery 15. The external short test can follow the guide lines described in UL-1642 (Underwriters Laboratories Inc.). Different isolation structures can also be used to simulate the thermal environment of a battery cell 22, battery module 20, or battery 15. The temperature profile can be determined by placing a number of thermocouples at different locations on the surface of the battery cell 22, module 20, or battery 15, to record the temperatures at various locations and for different voltages of the battery 15 or battery module 20 with respect to time. The resultant temperature profile can be used to determine the properties and the design of the current limiter 66 or the thermal conductor layer 60 of a battery 15.

The modeling described above provides the energy release—time profile when there is an electrical short in a battery cell 22, battery module 20 or battery 15, as well as the temperature change that occurs in the battery structure immediately after the electrical short. The design parameters of the current limiter 66, including its thickness, width, length, electrical resistance, thermal conductivity, and the melting temperature, are selected to limit or interrupt the current when an electrical short occurs. For example, if the calculation indicates that when a module developed an internal short, the surrounding battery cells or modules of a battery can provide a peak current of 20 mA. Then the shape and the material of the current limiter on each module can be selected so it will melt when the current that passes through the battery cell 22, module 20 or battery 15 exceeds a predefined current level, such as for example at least about 20 mA, or when the localized temperature at an electrical shorting point exceeds a predefined temperature level such as at least about 150° C. It should be understood that depending on the number of battery cells 22, their electrical connection whether serial or parallel, the output current of the battery 15, ambient temperature, and many other parameters, the particular characteristics of the current limiters 66 would change as would be apparent to those of ordinary skill in the art.

The battery 15 described herein provides better safety from over-heating, while still providing high specific energy capacity, and good volumetric energy density. While particular structures and sequences of process steps are used to illustrate embodiments of the battery and fabrication methods of the present invention, it should be understood that other structures or sequences of process steps can also be used as would be apparent to one of ordinary skill in the art. For example, the type of component films or their structure can be changed, and other layers can be deposited on top of or in between the different battery cells 22 or battery modules 20. Therefore, the spirit and scope of the appended claims should not be limited to the description of the preferred versions contained herein.

What is claimed is:

1. A rechargeable battery comprising:
(a) a battery cell comprising a plurality of battery component films on a substrate, the battery component films including at least a pair of electrodes about an electrolyte; and
(b) a current limiter electrically coupled to the battery cell to limit the current flowing through the battery cell when (i) the current flowing through the battery cell exceeds a predefined current, (ii) the temperature of the battery cell exceeds a predefined temperature, or (iii) both.

2. A battery according to claim 1 wherein the current limiter comprises an interrupter line.

3. A battery according to claim 2 wherein the interrupter line comprises a serpentine line.

4. A battery according to claim 1 wherein the current limiter comprises a material having a melting temperature of less than about 300° C.

5. A battery according to claim 1 wherein the current limiter comprises a material that increases resistance by at least about 10 ohms when subjected to a current that exceeds 20 mA.

6. A battery according to claim 1 wherein the current limiter comprises a material that increases resistance by at least about 10 ohms when heated to a temperature that is at least about 100° C.

7. A battery according to claim 1 wherein the current limiter comprises at least one of indium, tin, bismuth, or their alloys.

8. A battery according to claim 1 comprising a battery module comprising a plurality of the battery cells, and wherein the current limiter is electrically connected to one or more of the battery cells or to the battery module.

9. A battery according to claim 8 wherein the battery module comprises top and bottom surfaces that are each covered by a thermal conductor layer.

10. A battery according to claim 9 wherein the current limiter is on at least one of the thermal conductor layers.

11. A battery according to claim 9 wherein the thermal conductor layer comprises a metal, metal compound, or metal alloy.

12. A battery according to claim 11 wherein the thermal conductor layer comprises a foil.

13. A battery according to claim 8 further comprising a protective casing around the battery module.

14. A battery according to claim 13 comprising a plurality of battery modules, and wherein the current limiter is electrically connected to one or more of the battery cells, battery modules or battery.

15. A rechargeable battery comprising:
(a) a battery module comprising a plurality of battery cells, each battery cell comprising a plurality of battery component films on a substrate, the battery component films including at least a pair of electrodes about an electrolyte; and
(b) a current limiter electrically coupled to the battery module to limit the current flowing through the battery module when (i) the current flowing through the battery module exceeds a predefined current, (ii) the temperature of the battery module exceeds a predefined temperature, or (iii) both.

16. A battery according to claim 15 wherein the current limiter comprises an interrupter line electrically coupling a terminal of a battery cell to an electrical contact of the battery module.

17. A battery according to claim 15 wherein the current limiter comprises a material having a melting temperature of less than about 300° C.

18. A battery according to claim 15 wherein the current limiter comprises at least one of indium, tin, bismuth, or their alloys thereof.

19. A battery according to claim 15 wherein the rechargeable battery comprises a plurality of the battery modules.

20. A battery according to claim 15 wherein the battery module comprises top and bottom surfaces that are each covered by a thermal conductor layer, and the current limiter is positioned on at least one of the thermal conductor layers.

21. A battery according to claim 15 further comprising a protective casing around the battery module.

22. A method of fabricating a rechargeable battery, the method comprising:
(a) forming a battery cell comprising a plurality of battery component films on a substrate, the battery component films including at least a pair of electrodes about an electrolyte; and
(b) forming a current limiter electrically coupled to the battery cell to limit the current flowing through the battery cell when (i) the current flowing through the battery cell exceeds a predefined current, (ii) the temperature of the battery cell exceeds a predefined temperature, or (iii) both.

23. A method according to claim 22 comprising forming a current limiter that comprises an interrupter line.

24. A battery according to claim 22 comprising forming a current limiter comprising a material having a melting temperature of less than about 300° C.
